(19) United States
(12) Patent Application Publication
(10) Pub. No.: US 2020/0258051 A1
(43) Pub. Date: Aug. 13, 2020

(54) AUTOMATIC ONLINE MEETING ASSIGNMENT TRIGGERED BY USER LOCATION

(71) Applicant: Citrix Systems, Inc., Fort Lauderdale, FL (US)

(72) Inventor: Chao MA, Chengdu (CN)

(21) Appl. No.: 16/273,846

(22) Filed: Feb. 12, 2019

(51) Int. Cl. G06Q 10/10; H04L 29/08

(52) U.S. Cl. CPC G06Q 10/1095; H04L 67/18

(57) ABSTRACT

Embodiments disclosed herein describe automatically creating by a meeting intermediary an online meeting using an online meeting tool responsive to determining attendees of a calendar event are at different locations. A meeting intermediary can identify an attendee using an attendee identifier within a calendar event of an electronic calendar application. The meeting intermediary can determine that the location of the first attendee is different from the location of the second attendee. When the meeting intermediary determines that an attendee is at a different location, the meeting intermediary can request an online meeting identifier and toll-free phone number based on the location from one or more online tools. The meeting intermediary can include or attach the online meeting identifier and phone number to the calendar event.

### FIELD OF THE DISCLOSURE

The present application generally relates to online meeting scheduling, including systems and methods for automatically creating an online meeting for an event when meeting participants are in different locations.

### BACKGROUND

Many companies are international companies with employees located at different offices and in different time zones. Using an online meeting tool may be useful to bridge the geography and time zone differences between employees and/or other meeting attendees. However, in many instances, the meeting organizer does not setup or include an online meeting when meeting attendees are in different locations or time zones. The meeting organizer may forget to include an online meeting or may not realize that attendees are in different office locations.

### BRIEF SUMMARY

The present disclosure is directed towards systems and methods of automatically adding online meetings to events when attendees are in different locations. Technology based office productivity tools, such as calendaring applications (e.g., Microsoft Outlook) are useful for electronically creating and organizing events, such as meetings, via computing devices of different attendees at mutual available times and locations. Other technology work productivity tools are online meeting and conferencing platforms which enables users to meet with other computer users, customers, clients or colleagues via the Internet in real-time. In creating an event in a calendaring application, sometimes a meeting organizer will also need to separately create an online meeting via an online meeting and conferencing platform and include information about the online meeting into the event in the calendaring application or send out the online meeting information separately via email or the online meeting and conferencing platform. This is in the event that the organizer knows beforehand that attendees to the meetings need an online meeting. In many cases, the attendees may send a reminder or request to the organizer to create such an online meeting responsive to receiving the calendar event. This creates inefficiencies as after the organizer already created and distributed the calendar event, the organizer will create the online meeting via the online meeting and conferencing platform and then will also need to update the calendar event with information or using the online meeting and re-distribute the calendar event with this information to all the attendees.

The technical implementation of the meeting intermediary of the present solution improves the efficiency, operation and performance of these technology based office productivity tools by integrating the calendaring application with the online meeting platform to provide improved user experience by automatically identifying those situations in which an online meeting should be created and distributed with the calendar event and avoiding the extra steps of separately using the online meeting tool to do so. The meeting intermediary provides intelligence implemented in logic to determine meeting rooms based on availability and attendees' locations and time zones and further based on attendees and organizers geographical or office locations, determine whether an online meeting should automatically be created via an online meeting tool and included in the calendar event. With this smart meeting intelligence, the organizer can create a calendar event and seamless and automatically have an online meeting automatically created for the calendar event and distributed with the calendar event to the attendees.

In some aspects, the methods described may automatically create an online meeting using an online meeting tool responsive to determining attendees of a calendar event are at different locations. The meeting intermediary can identify an attendee using an attendee identifier within a calendar event of an electronic calendar application. The meeting intermediary can determine that the location of the first attendee is different from the location of the second attendee 202. In one or more embodiments, the meeting intermediary can determine the location of the attendees by using location information in the attendee profiles. The meeting intermediary can also determine the location of the attendees in other ways described herein. When the meeting intermediary determines that the second attendee is at a different location, it can request an online meeting identifier and toll-free telephone number from one or more online meeting tools. The meeting intermediary can then receive a unique identifier and toll-free telephone numbers for an online meeting event facilitated by the one or more online meeting tool and incorporate the unique identifier into the calendar event published to the attendees.

The system can identify the attendee identifiers responsive to the creation of the calendar event in the electronic calendar. The system can identify and display in the calendar event a list of meeting locations available at a location of an attendee. In one or more embodiments, the system computes a time zone for each of the attendees based on the profiles of the attendees and incorporates toll-free telephone numbers corresponding to the attendee location within the calendar event. In one or more embodiments, the system schedules an online meeting corresponding to the time zone within the calendar event. In one or more embodiments, the system incorporates a toll-free telephone number corresponding to the attendee location for the event to be facilitated via the online meeting tool into the calendar event.

The system described herein may be a system to automatically create an online meeting identifier (ID) and toll free phone number using one or more online meeting tools responsive to determining attendees of a calendar event are at different locations. System components communicate to create automatically an online meeting ID and toll-free telephone numbers using one or more online meeting tools responsive to determining that attendees of a calendar event (are at different locations. In one or more embodiments, the meeting intermediary identifies an attendee using an attendee identifier within a calendar event of an electronic calendar application. In one or more embodiments, the meeting intermediary determines that the location of the first attendee is different from the location of the second attendee by using location information in the attendee profiles. When the meeting intermediary determines that the second attendees at a different location, it can request an online meeting identifier from one or more online meeting tools. In one or more embodiments, when the meeting intermediary determines that the second attendee is at a different location, the meeting intermediary requests a toll-free phone number for the attendee from one or more online meeting tools. The meeting intermediary can then receive a unique identifier for an online meeting event facilitated by the online meeting tool and incorporates the unique identifier into the calendar event published to the attendees.

In some aspects, the present solution is directed to a method for automatically creating an event for an online meeting tool responsive to determining attendees of a calendar item are at different locations. The method includes identifying, by a meeting intermediary, a plurality of attendees from a calendar item in an electronic calendar. The meeting intermediary determines a location of each attendee of the plurality of attendees and that the location of at least one attendee is different from the location of another attendee. The method further includes requesting, by the meeting intermediary, an online meeting identifier from an online meeting tool and receiving, by the meeting intermediary responsive to the request, a unique identifier from the online meeting tool for an event to be facilitated via the online meeting tool. The meeting intermediary includes the unique identifier for the event of the online meeting tool into the calendar item to be published to the plurality of attendees.

In some embodiments, the meeting intermediary identifies a plurality of attendee identifiers of the calendar item in the electronic calendar. Each of the plurality of attendee identifiers may be associate with an attendee profile of one of the plurality of attendees. The meeting intermediary may determine the location of each of the plurality of attendees from the attendee profile. The meeting intermediary may also determine the location, such as their current location or location at the time of the meeting, of each of the plurality of attendees based on each attendee's electronic calendar. The meeting intermediary may compute a time zone for each of the plurality of attendees and incorporating within the calendar item one or more telephone numbers corresponding to the time zone.

### BRIEF DESCRIPTION OF THE FIGURES

The foregoing and other objects, aspects, features, and advantages of the present solution will become more apparent and better understood by referring to the following description taken in conjunction with the accompanying drawings, in which:

FIG. 1 is a block diagram of embodiments of a computing device;

FIG. 2A is a block diagram of an example embodiment of a system for automatically adding online meetings to calendar events when all attendees are not in the same location;

FIG. 2B is a diagram of the flow of events that occurs to add an online meeting when a meeting is initiated by the meeting initiator.

FIG. 2C is an image of a representative outcome of using an embodiment of the meeting intermediary to schedule online meetings when attendees are not all in the same location.

FIG. 3 is a flow diagram of an embodiment for a method of automatically adding online meetings to calendar events when not all attendees are in the same location.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a computing environment which may be useful for practicing embodiments described herein; and

Section B describes systems and methods for automatically scheduling an online meeting and adding to a calendar event responsive to attendees not being in the same location.

### A. Computing Environment

Prior to discussing the specifics of embodiments of the systems and methods detailed herein in Section B, it may be helpful to discuss the computing environments in which such embodiments may be deployed.

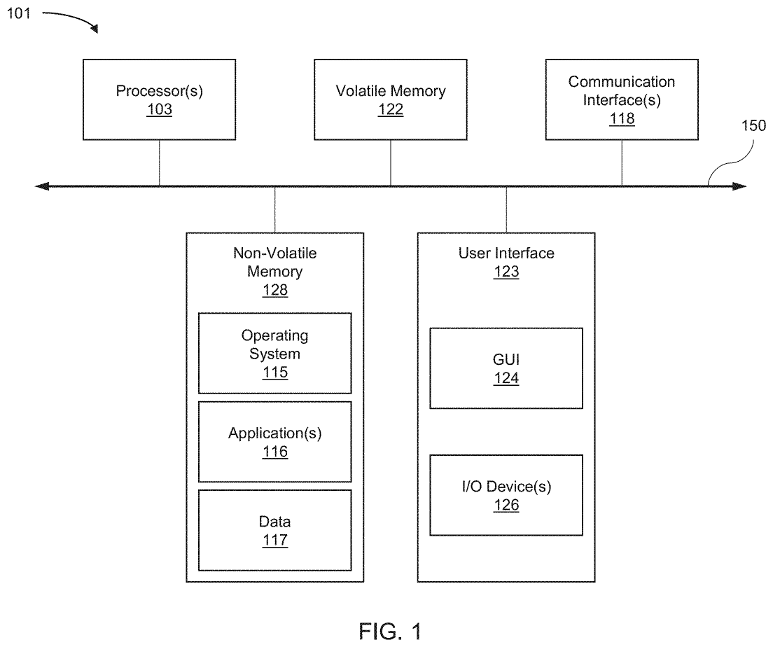

As shown in FIG. 1, computer 101 may include one or more processors 103, volatile memory 122 (e.g., random access memory (RAM)), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, one or more accelerometers, etc.). Non-volatile memory 128 stores operating system 115, one or more applications 116, and data 117 such that, for example, computer instructions of operating system 115 and/or applications 116 are executed by processor(s) 103 out of volatile memory 122. In one or more embodiments, volatile memory 122 may include one or more types of RAM and/or a cache memory that may offer a faster response time than a main memory. Data may be entered using an input device of GUI 124 or received from I/O device(s) 126. Various elements of computer 101 may communicate via one or more communication buses, shown as communication bus 150.

Computer 101 as shown in FIG. 1 is shown merely as an example, as clients, servers, intermediary and other networking devices and may be implemented by any computing or processing environment and with any type of machine or set of machines that may have suitable hardware and/or software capable of operating as described herein. Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In one or more embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In one or more embodiments, the “processor” may be one or more physical processors or one or more “virtual” (e.g., remotely located or “cloud”) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computer 101 to access a computer network such as a Local Area Network (LAN), a Wide Area Network (WAN), a Personal Area Network (PAN), or the Internet through a variety of wired and/or wireless or cellular connections.

In described embodiments, the computing device 101 may execute an application on behalf of a user of a client computing device. For example, the computing device 101 may execute a virtual machine, which provides an execution session within which applications execute on behalf of a user or a client computing device, such as a hosted desktop session. The computing device 101 may also execute a terminal services session to provide a hosted desktop environment. The computing device 101 may provide access to a computing environment including one or more of: one or more applications, one or more desktop applications, and one or more desktop sessions in which one or more applications may execute.

Additional details of the implementation and operation of network environment, computer 101 and client and server computers may be as described in U.S. Pat. No. 9,538,345, issued Jan. 3, 2017 to Citrix Systems, Inc. of Fort Lauderdale, Fla., the teachings of which are hereby incorporated herein by reference.

### B. Systems and Methods for Automatically Scheduling Online Meetings

The present disclosure is directed towards systems and methods of automatically scheduling an online meeting responsive to meeting attendees being in more than one location or in location(s) different from the meeting organizer. Under typical techniques, online meetings and/or conference call telephone numbers are established and/or scheduled separately from meetings, such as meetings via a calendar application. Many companies are international companies with employees in locations across the world or otherwise different geographies and time zone. Additionally, many companies have cross-location teams. This can create a problem when an employee schedules a meeting. The meeting initiator must recognize that an online meeting is necessary and remember to schedule the online meeting. The meeting initiator must also remember to include the meeting in the calendar invitation. Additionally, if the meeting initiator wants to allow for telephone dial-in, the meeting initiator must remember to include a telephone dial-in number for the online meeting and/or calendar meeting. In a desired situation, the meeting initiator would schedule a toll-free telephone number 275 for each attendee not in the same office.

Often meeting initiators fail to do this leading to inefficiency. Sometimes meeting initiators fail to consider the time zone or location of the attendee. Additionally, meeting initiators may schedule a call in a long-distance area code leading to an increase in cost for the attendee. This inefficiency can lead to repeated attempts to schedule the meeting, or the inability of an invited attendee to attend the meeting.

To address the technical challenges and drawbacks in scheduling meetings, particularly online meetings, the described systems and methods automatically create and/or assign an online meeting based on the locations of attendees and the meeting initiator. When a meeting is scheduled that has multiple attendees, the meeting intermediary may check to see whether all the attendees are in the same location. If they are not, the meeting intermediary may schedule an online meeting. The meeting intermediary may schedule a telephone number in the local time zone and area code of one or more remote attendees. The meeting intermediary may schedule conference rooms, if desired, at one or more of the locations of the attendees.

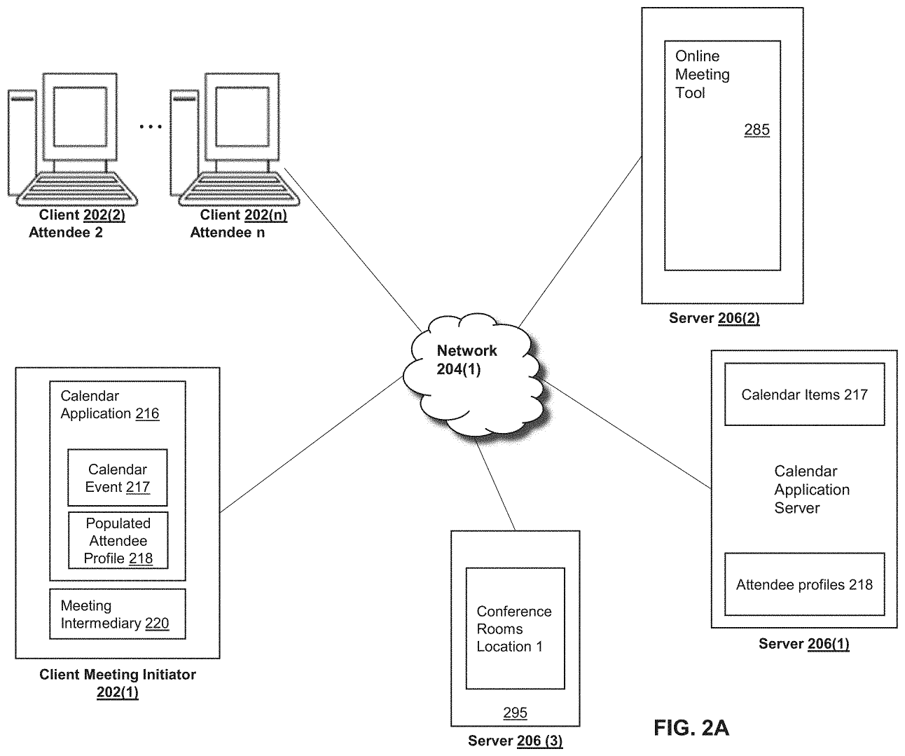

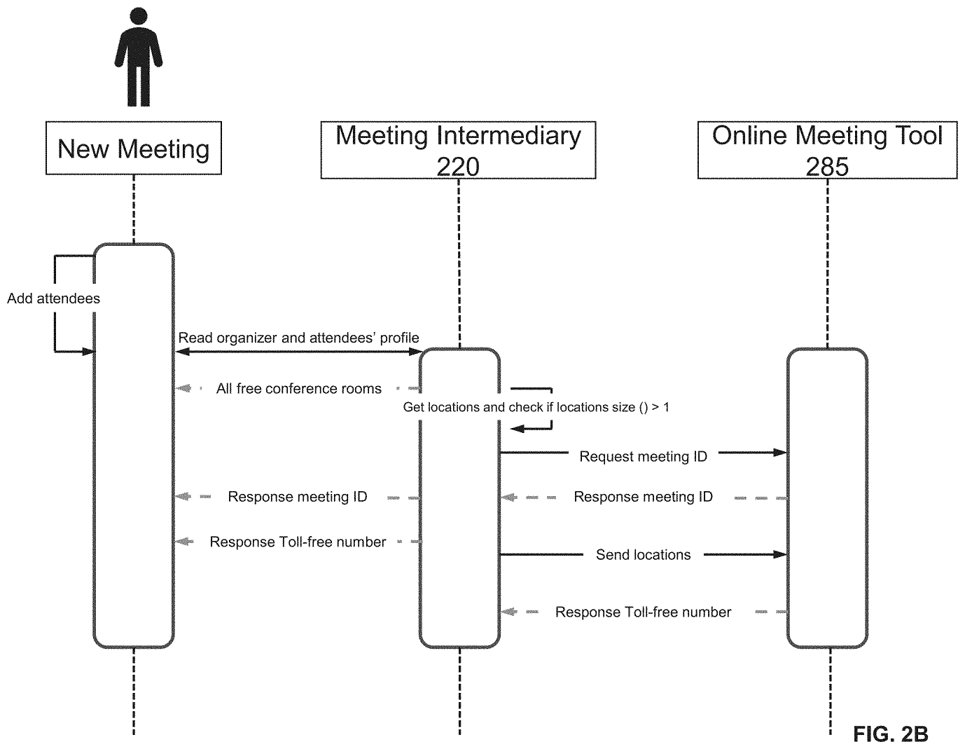

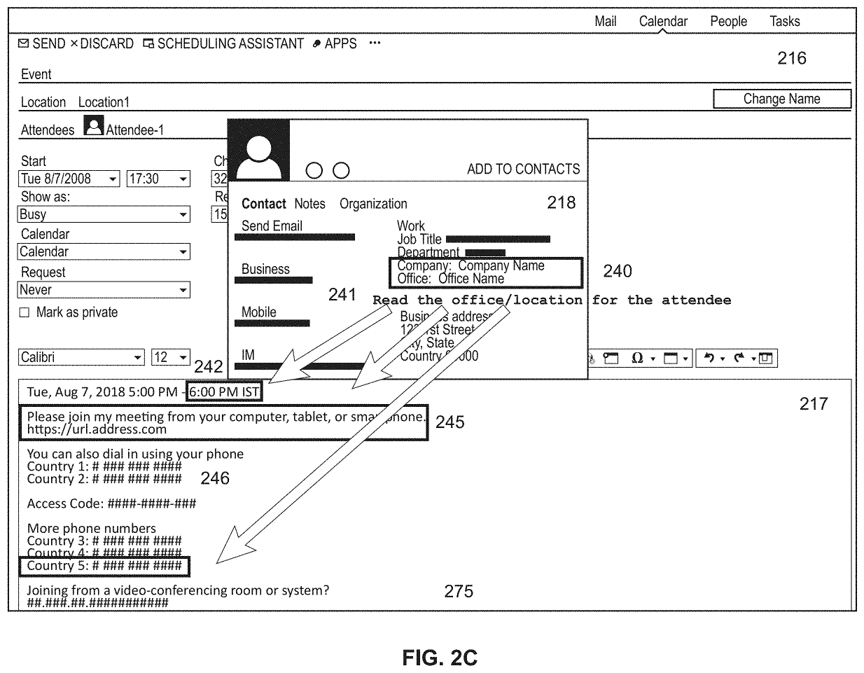

FIG. 2A, depicts a block diagram of a system for automatically scheduling an online meeting and adding it to a calendar event, such as responsive to client attendees (202) having different locations. In overview, the system may include client devices of a client meeting initiator 202(1) (.e.g. meeting organizer), client attendees 202(2 . . . n) (all generally referenced to as clients 202 or client attendees 2002), a mail exchange server 206(1), an online meeting tool server 206(2), and conference room location servers 206(3 . . . n) communicatively coupled via a network 204. Any of the clients 202 may include a calendar application 216 that may also communicate over the network 204 with a mail exchange or calendar server 206(1). The calendar application 216 may enable users such as any of the client attendees on the respective devices to create or schedule a calendar event 217, which may be stored on the client devices and/or on the calendar application server 206(1). The online meeting tool server(s) 206(2) may operate the online meeting tool 285. The conference room location server 206(3) may include the identity of available conference rooms 295. The meeting intermediary 220 may operate on a client 202 and/or servers 206 and use attendee profiles 218 stored on a clients and/or calendar application server 206 to determine locations and time zones of attendees for a calendar item and communicate with online meeting tool to create an online meeting tool for the calendar item.

Any of the components of the system 200 may be implemented using hardware, software, or a combination of hardware or software, such any of the hardware and software detailed above in connection with FIG. 1. For instance, any of the calendar application, meeting intermediary, online meeting tool and clients and servers can include any application, program, library, script, task, service, processor any type and form of executable instructions executing on the hardware of the device, such as a hardware processor or circuitry of client or server.

Referring in further detail to FIG. 2A, clients 202(1-n), referred to collectively or singularly below as client 202, may be any type and form of computing device. For example, the client 202 may include desktop computers, laptop computers, notebook computers, mobile or portable computing devices, tablet computers, smartphones, internet of things (IoT) devices, personal digital assistants, etc. To provide for interaction with a user, the client may include a display device, or monitor, for displaying information to the user and a keyboard and a pointing device, e.g., a mouse or a trackball, by which the user can provide input to the computing device. In one or more embodiments, the client 202 may be any collection of software or hardware components including one or more processors executing an arrangement of instructions contained in memory. In some embodiments, the instructions can be read into memory from another computer-readable medium, such as a storage device. The computing environment may execute or operate an application that accesses, processes or uses a data file. The computing environment, application and/or data file may be delivered via the network 204 or the server 206. The client 202 may execute, operate or otherwise provide an application, such as calendar application 216, which can be any type and/or form of software, program, or executable instructions such as any type and/or form of web browser, web-based client, client-server application, a thin-client computing client, an ActiveX control, or a Java applet, or any other type and/or form of executable instructions capable of executing on client 202. In one or more embodiments, the application may be a server-based or a remote-based application executed on behalf of the client 202 on a server 206.

In one or more embodiments, the servers 206 pictured in FIG. 2A, servers 206(1-3), referred to collectively or singularly below as server 206, may be comprised of a computing device. The servers may be embodied as a network device or intermediary device on the network. In one or more embodiments, the servers 206 may be comprised of a computing environment and application. A server may include a file server, application server, web server, proxy server, appliance, network appliance, gateway, gateway, gateway server, virtualization server, deployment server, secure sockets layer virtual private network (“SSL VPN”) server, or firewall. Any of the servers may operate in a cloud computing environment, such as a cloud computing environment provided by a third party (e.g., Microsoft, Amazon, etc.). In one or more embodiments, the servers 206 may be comprised of multiple servers 206. In one or more embodiments, the servers may form a logical group of servers and be referred to as a server farm. In some of these embodiments, the servers 206 may be geographically dispersed. In some cases, a farm may be administered as a single entity. In other embodiments, the server farm comprises a plurality of server farms. In some cases, the servers 206 or farms are administered by multiple entities. In some embodiments, one or more servers 206 execute one or more applications on behalf of one or more clients 202.

In some embodiments, the clients 202 and servers 206 can be heterogeneous. One or more of the clients 202 or servers 206 can operate according to one type of operating system platform (e.g., any version of WINDOWS, manufactured by Microsoft Corp. of Redmond, Wash.), while one or more of the other clients or servers 206 can operate on according to another type of operating system platform (e.g., Unix or Linux). The servers 206 and clients 202 may be interconnected using a wide-area network (WAN) connection or medium-area network (MAN) connection. For example, the system may include servers 206 and clients 202 physically located in different continents or different regions of a continent, country, state, city, campus, or room.

Still referring to FIG. 2A, the network 204 may comprise any type and form of network and networking protocols. Embodiments of the network 204 provide interconnection between components of the system, such as between clients and servers. The network may provide communication between the clients, servers, and other devices. Networks may be personal area networks (PAN), local area networks (LAN), Wireless LAN, campus area networks (CAN), metropolitan area networks (MAN), wide area networks (WAN), storage area networks (SAN), the Internet, and others. Possible network architectures include bus, star, ring, mesh, tree, fully connected, and many others. The network may be a virtual network, such as an overlay network. The network may use any of a variety of communication protocols and protocol stacks. The protocols may be connection-oriented or connectionless. The protocols may use circuit mode, packet switching or other methods. The protocols may use hierarchical addressing or flat addressing or other methods. Example protocols are IEEE 802, TCP/IP, SONET/SDH, Asynchronous Transfer Mode and many others.

In one or more embodiments, the client meeting initiator 202(1) is the client device of the meeting organizer, also referred to as the scheduling attendee, used to create the calendar item 217, or otherwise initiate, establish, update or process the calendar item. The client device of the meeting initiator (also sometime referred to as the client meeting initiator or meeting initiator) can include one or more of the following: a calendar application 216, calendar events 217, attendee profiles 218, and/or a meeting intermediary 220. The client meeting initiator may execute the calendar application to create the calendar event. The client meeting initiator may execute the meeting intermediary with the calendar application. The client meeting initiator can execute the meeting intermediary in response to a triggering event. The triggering event may be scheduling a meeting with the calendar application or other application. The triggering event may be scheduling a meeting with a workflow, work management, collaboration, or sharing application like Slack.

In some embodiments, the client requests delivery of the meeting intermediary 220 from an application delivery system comprising any one or more of the following: the network 204(1), other clients 202, or servers 206. In some embodiments, the client 202 may execute the meeting intermediary locally after retrieving application files comprising the meeting intermediary application. The client 202 may execute the meeting intermediary by accessing an application delivery system. The client 202 may trigger the meeting intermediary stored and/or executed on another device or via a network in response to a triggering event.

In one or more embodiments, client attendees 202(2 . . . n) are clients used by users who are attending the calendar item, such as a meeting. The client attendees 202(2 . . . n) may interact with the network 204 to receive information such as calendar items 217, email, online meeting information, applications, and attendee profile 218 information from the calendar application server 206 and transmit updates to the mail exchange server via the network 204. In some instances, client attendees 202(2 . . . n) communicate with each other and with the client meeting initiator to send and receive information such as calendar items 217, email, applications, online meeting information, and/or attendee profile 218 and updates regarding the same.

In some embodiments, the calendar application 216 is an application that allows users to view and/or interact with appointments, meetings, events and any other type of calendar item 217. The calendar application 216 allows a client meeting initiator 202(1) to request, establish and/or schedule a calendar item 217 and distribute, communicate, publish and/or share that item with client attendees 202(2-n). In one or more embodiments, the calendar application 216 may be an application that runs on a client or a server, or which has a client-side portion that runs on the client and a server-side portion that runs on the server. In one or more embodiments, the calendar application 216 may be a plugin component, such an ActiveX control or Java control or script that is loaded into and executed by an application or an operating system of a device. In another embodiment, the calendar application may be a set of executable instructions loaded into and run by an application, such as a browser. In one or more embodiments, a program obtains, downloads, or receives the calendar application via the network 204 or servers 206 from another computing device and installs and configures on the client 202.

The calendar application 216 may be a commercially available product or may be an application designed and constructed to provide calendar and/or meeting and event functionality. Commercial calendar applications include but are not limited to the following examples:

Microsoft Outlook, Google Calendar, Apple iCal, Slack, Mozilla Thunderbird, iPhone Calendar, Blackberry Calendar, Lotus notes, Teamweek, Vantage, Accompany, Fantastical, Calendars 5, Business Calendar, Accompany, Timepage, ZenDay, Newton Calendar, TimeTree, SaiSake, Shift.Cal, AwesomeCalendar, CloudCal, aCalendar and many more. The calendar application 216 may be any type and form of software program or application, executable on a device, and used to schedule meetings, appointments or events. The calendar application may be part of a collaboration tool or workflow application such as Slack, Guru, Flock, Cliq, Zoho, Google Hangouts, Cisco Spark, Fleep, Workzone, Jostle, Hive, Workplace by Facebook, Fuze, and many others. The calendar application may be part of a social media application such as Reddit, Instagram, YouTube, Facebook, Google, Pinterest, Snapchat, LinkedIn and many others.

The calendar application 216 may be configured to run on one or more servers 206, one or more clients 202, and/or a combination of one or more servers 206 and one or more clients 202. In some embodiments, the calendar application 216 has access to a calendar application server that can access and manage a data store for data related to the calendar application. In some embodiments, the calendar application 216 has access to the calendar application server, such as a mail exchange server 206(1) which can access and manage a server calendar data store. In some embodiments, the calendar data store can include calendar information, calendar events, email information among other things. In some embodiments, the calendar data is stored on the calendar application server 206(1). In some embodiments, the calendar data is stored on a client.

The calendar application 216 may be configured and/or constructed to create, establish, process, or receive as input from a user or another system, one or more calendar items. A calendar item 217, also referred to as a calendar event, may include any type of object or data item that electronically and/or graphically represents, specifies or configures an activity or event scheduled or to be scheduled among one or more users, such as attendees to a meeting. The calendar application 216 collects, organizes, and displays information and data associated with the user along, with or associated with a timeline for one or more calendar items 217. In some embodiments, the calendar items 217 are placed along a timeline at the time they occur or will occur. Examples of calendar items 217 are meetings, appointments, events, or activities scheduled or shared among one or more users. The calendar item 217 may include contact information (name, email addresses, phone numbers, addresses, office location, etc.) of any of the attendees and/or organizer. The calendar item 217 may include any information on a start time, end time, duration and/or time zone of an activity or event associated with the calendar item. The calendar item 217 may include any information on any telephone conference numbers and online meeting information, including links or uniform resource locations (URLs) related to the online meeting, such as those incorporated by the meeting intermediary. The calendar item 217 may include any description including text or other content describing the nature of the event or activity, such as an agenda for a meeting or notes entered by any user. The calendar item 217 may include attachments of any files to be distributed, shared, presented and/or opened, edited, reviewed and discussed among the attendees and/or organizer.

The creation of a calendar item may be triggered by actions performed by one or more users and/or a system or application. Examples include sending/receiving emails or sending/receiving invitations to participate in an activity. Each calendar item may be identified and selectable in the graphical interface of the calendar application and identified using a graphical icon and/or corresponding text. For example, a first user may send a second user an invitation to participate in an activity such as a meeting of a calendar item. In some embodiments, the second user may accept the invitation, establishing the meeting of the calendar item. In some embodiments, the user can access details about the activity or meeting by interfacing with the calendar item 217.

In some embodiments, the system includes a calendar application server, which in some cases may be referred to as a mail exchange server 106(1), such as for a mail tool as the calendar application (e.g., Microsoft Outlook) communicating with a back end application (e.g., Microsoft Exchange). The server 206(1) may be a social media server. The server 206(1) may include or execute a calendar application 216. In one or more embodiments, the mail exchange server includes one or more calendar events 217, such as stored in, for or by the calendar application. In one or more embodiments, the mail exchange server 206(1) includes or stores attendee profiles 218. In one or more embodiments, the mail exchange server 206(1) houses calendar and profile information and interacts with the network 204 to deliver information such as calendar items 217, email, online meeting information, applications, and attendee profile 218 information to the clients 202 and receives updates from the clients 202 via the network. In one or more embodiments, the calendar application server, such as a mail exchange server may use DSNP, MAPI, POP3, IMAP, EAS, SMP or other protocols to communicate with clients 202, such as the calendar application 216. In some embodiments, the server 206(1) runs one or more applications to run mail and calendaring applications 216 and to communicate with clients and other devices.

An attendee profile 218 may comprise data about a profile of an attendee. The attendee profile 218 can include personal and/or work related information about a user available to participate or be part or included in a calendar item. In some embodiments, the information included in the attendee profile may any of the following not limiting examples: name, image or picture, email address, social media identifier, names or accounts, phone number(s), hire or start date, location, title, department, manager(s), address(es), groups, etc. The attendee profile may also include one or more office locations of a user. The attendee profile may also include a history of one or more conference rooms used by the user. The attendee profile may include schedule and/or dates, days and/or times of availability and non-availability of a calendar of a user via the calendar application. The attendee profile may include events, meetings or appointments of the user in a calendar of the calendar application. In some embodiments, the attendee profile includes any of the information described, displayed or available via the example user interface of FIG. 2C.

In some embodiments, the attendee profile will have information about other attendees or the data from other attendee profiles 218. The information about the other attendees may be in the form of a pointer to a data set, data set, or association of the attendee profile 218 with other attendee profiles 218. In one or more embodiments, the attendee profile 218 is generated by the calendar application 216. In other embodiments, the attendee profile is obtained from another application, such as an active directory server or human resources system or application. The attendee profile 217 may include a group of settings that define how the calendar application 216 is set up or configured for the user. The attendee profiles 218, and/or copies or caches thereof, may be housed or stored in various locations including the clients 202 and/or servers 206 on the network, or other locations, such as a database or a cloud service, cloud platform or cloud server. In some embodiments, one or more devices may have or use a pointer to the attendee profile stored on a specific device.

The online meeting tool server 206(2) may comprise any type and form of one or more servers that houses, stores and executes an online meeting tool. The online meeting tool server may be a cloud based service, platform or server providing access and use of a multi-tenant online meeting tool. The online meeting tool server may be one or more servers of an entity or enterprise to provide an online meeting tool for use by the entity or enterprise.

In one or more embodiments, the online meeting tool 285 is any type and form of online meeting and/or conferencing technology, application, platform or service. The online meeting allows or enables users to meet with other computer users, customers, clients or colleagues via the Internet in real-time. The online meeting tool may provide video conferencing and/or telephone conferencing. The online meeting tool may provide tools and/or applications for users of the online meeting to present, share, distribute, create, edit, revise, collaborate on any one or more files, documents, media or content. In one or more embodiments, the online meeting tool 285 may be an application. The online meeting tool 285 may comprise of a plugin component, such an ActiveX control or Java control or script that is loaded into and executed by an application. The online meeting tool 285 may comprise a set of executable instructions loaded into and run by an application, such as a browser. The online meeting tool may be, but is not limited to, a commercial application. Examples of commercial applications include but are not limited to GoToMeeting, Microsoft Teams, Skype, Skype for Business, Webex, Zoom, Openmeetings, Yugma, MegaMeeting, Ekiga, Join.me, Google Meet, Amazon Chime, and many others. In one or more embodiments, the online meeting tool may comprise a server-side component, application or service on server 206(2). In some embodiments, the online meeting tool may comprise a client-side component, application or service that resides on a client 202.

An online meeting tool may provide an interface, such as graphical user interface and/or an application programming interface (API) for requesting, scheduling and/or established an online meeting. The online meeting tool may provide one or more APIs, web-services or other interfaces for another device, system or application to request and establish a meeting, obtain a meeting identifier and any other information related to the online meeting. For example, the calendar application or meeting intermediary may use APIs to interact or communicate with the online meeting tool to create an online meeting and obtain a meeting identifier. The online meeting tool may generate and provide a meeting identifier, referred to as meeting ID, for an online meeting, such as to the requestor and/or any attendees. The meeting identifier may comprise any numerical, alpha-numerical and/or text based identifier for uniquely or specifically identifying the online meeting from other online meetings that may be hosted or provided by the online meeting tool. The online meeting tool may provide one or more phone numbers, including toll-free numbers, when available, as part of the description or data for the online meeting. The phone numbers may be identified with, associated with or assigned to a geographical location, such as city, state or country. The online meeting tool may provide one or more links or uniform resource locators (URLs) for the online meeting organizer and attendees to access, connect, join or interact with the online meeting via the online meeting tool. The online meeting tool may provide one or more links or uniform resource locators (URLs) for the organizer and/or attendees to download and/or install any software components for use with the online meeting tool.

In some embodiments, the calendar application may include information about conference rooms of one or more entities and the available of these conference rooms. In some embodiments, the calendar application or meeting intermediary may interface to a system, application, database or server to identify conferences rooms and their availability, such as via one or more conference room servers 206(3) depicted in FIG. 2A.

In some embodiments, the conference room servers 206(3) are servers that include information about the identity and availability of conference rooms at various locations, such as for an entity or enterprise. In some embodiments, the calendar application or meeting intermediary 202 may query a conference room location based on the location of an attendee or organizer of a calendar item, such as based on information in their respective attendee profile. In one or more embodiments, the calendar application or meeting intermediary may determine one or more conference room resources for the attendee based on the attendee, the location of the attendee, and open conference rooms as indicated by the application or database of the conference room server(s). In some embodiments, in accordance with a set of predetermined open conference room locations stored or accessible via the conference room application or database 295, the calendar application or meeting intermediary 220 may identify a conference room for the calendar item or online meeting from one or more available conference rooms. The predetermined conference room locations maintained on the conference room application or database 295 may specify a set of conference room locations for each location of a user. For example, each predetermined conference room location in the application/database 295 may specify available conference rooms for a corresponding location at a corresponding time.

Still referring to FIG. 2A, the meeting intermediary 220 is designed, constructed and/or implemented to automatically create an online meeting via the online meeting tool for a calendar item, such as a calendar event, responsive to determining that one or more attendees of a calendar item are at different locations. The meeting intermediary may be an application, program, library, process, service, task or any other type and for of executable instructions executable on one or more devices. In one or more embodiments, the meeting intermediary 220 may be an extension (e.g., an add-on, an add-in, an applet or a plug-in) to another application (e.g., a calendar application, social media application, web browser, such as an application installed on a client 202. The meeting intermediary 220 may comprise a plugin component, such an ActiveX control or Java control or script that is loaded into and executed by an application, such as the calendar application. In another embodiment, the meeting intermediary 220 comprises a set of executable instructions loaded into and run by an application, such as a browser. In one or more embodiments, the meeting intermediary 220 may be a standalone application and may run as a process separate from the calendar application. In some embodiments, the meeting intermediary 220 may execute as part of the process of the calendar application. In some embodiments, the meeting intermediary may be part of the calendar application server and run as part of the calendar application on the server or as a separate process on the server. In some embodiments, the meeting intermediary may run or operate on any network device or server in the network between the calendar application/calendar application server and the online meeting tool.

The meeting intermediary may be configured and implemented to interface, integrate or communicate with each of one or more calendar applications and one or more online meeting tools. The meeting intermediary may implement one or more application programming interfaces (APIs) to access and/or work with the one or more calendar applications, such as to detect creation of a calendar item, obtain calendar item information and update calendar item information. The meeting intermediary may implement one or more application programming interfaces (APIs) to access and/or work with the one or more online meeting tools, such as to create an online meeting, obtain meeting identifier and meeting information, such as phone numbers. The meeting intermediary may implement one or more APIs to access and/or obtain attendee profiles from the calendar application and/or calendar application server. The meeting intermediary may implement one or more APIs to access and/or obtain conference room information and availability from the one or more conference room servers and any applications or databases on the one or more conference room servers.

In some embodiments, the meeting intermediary is implemented to detect that a calendar item is being created or has been created. The meeting intermediary may have any API hooks or suitable functions and/or logic to detect an event of a calendar item being created, scheduled, published and/or distributed. In one or more embodiments, such as responsive to a calendar item being created, scheduled, published and/or distributed, the meeting intermediary 220 identifies an attendee using an attendee identifier, such as an email address or contact name, within a calendar item 217, such as calendar event, of an electronic calendar provided by the calendar application. The meeting intermediary 220 can determine that the location of any of the attendees is different from the location of any other attendee, such as the event or item organizer. In one or more embodiments, the meeting intermediary determines the location of the attendee by using location information in the attendee profiles 218. The meeting intermediary may determine the location of the attendee in other ways.

When the meeting intermediary determines that at least one attendee is at a different location, the meeting intermediary can request to establish an online meeting with the online meeting tool, such as making an API request over the network. The meeting intermediary can request an online meeting identifier from one or more online meeting tool 285. The meeting intermediary can communicate to an online meeting tool the locations of the attendees and desired time of the meeting to obtain an online meeting ID and/or telephone numbers, such as toll-free numbers 275, corresponding to the attendee locations from the online meeting tool.

In one or more embodiments, the meeting intermediary 220 receives a meeting identifier for an online meeting event facilitated by the online meeting tool 285 and incorporates the meeting identifier into the calendar event 217 published to the attendees 202(1-n). In one or more embodiments, the meeting intermediary 220 sends the attendee 202 locations to an online meeting tool 206(2), which generates or provides a toll-free telephone number or telephone number for each attendee location for the online meeting. The meeting intermediary 220 may include or attach the online meeting and toll-free area code number 275 to the calendar item. The meeting intermediary may attach a file to the calendar item regarding the online meeting. The meeting intermediary may include or incorporate in a subject, body or content of the calendar item the information regarding the online meeting, such as by including URLs to corresponding online meeting tool links and one or more telephone numbers. The meeting intermediary may include or incorporate in a subject, body or content of the calendar item the information regarding the conference rooms.

The meeting intermediary may be implemented to modify the calendar item to include any information regarding the online meeting. The meeting intermediary may be implemented to modify the calendar item prior to the calendar item being shared, distributed or published across the attendees. The meeting intermediary may be implemented to modify the calendar item prior to the calendar item being shared, distributed or published across the attendees. The meeting intermediary may be implemented to modify the calendar item while the calendar item is being created or established. The meeting intermediary may be implemented to modify the calendar item while the calendar item is being created or established. The meeting intermediary may be implemented to modify the calendar item upon or after the calendar item is being created or established. The meeting intermediary may be implemented to modify the calendar item upon or responsive to establishing the online meeting and/or receiving the online meeting information, such as meeting identifier and telephone numbers.

Using the location of any attendees or clients of the attendees, the meeting intermediary 220 may identify or select the conference room to assign to the user in accordance with the conference room location 295. The meeting intermediary 220 may identify the conference room to assign to the user based on locations identified as within a proximity of, or associated with the location of client. In one or more embodiments, the meeting intermediary software may access server 206(3) via the network or directly and traverse through the conference room location data maintained on the conference room database or app 295 to search for an open conference room in the location of the client 202. In one or more embodiment, the meeting intermediary 220 may find or identify a subset of predetermined conference rooms with one or more location identifiers matching the location of the user included in the request from the client 202. In one or more embodiments, the meeting intermediary 220 may find or identify the subset of predetermined conference rooms with the one or more location identifiers matching one of the set of location identifiers identified as within proximity of, or associated with the location of the user.

In one or more embodiments, the meeting intermediary 220 may determine a set of conference rooms assigned to other users at and/or within proximity to the location of the user indicated in the request and the set of locations approximate or associated with the location of the user. Other conference rooms at the location of the user that sent the request may be accessed by other users. As such, the resources of the rooms assigned to other users may be in use. The meeting intermediary 220 may remove the set of conference rooms assigned to other users from the set of conference rooms at the location of the user. From the available set of conference rooms, the meeting intermediary 220 may determine a number of available conference rooms at the location of the client attendee and assign the available conference room. Subsequently, the meeting intermediary 202 may receive the response indicating the assignment of the conference room to the client attendee. The meeting intermediary 202 may translate the response and update the calendar event to show the location of the available conference room(s) to the client attendee.

The location may be specified by the user, e.g., via user input using an interface of the meeting intermediary 220, for instance. The location of the user may also be stored in the attendee profile of the user. The attendee profile may be stored in the calendar application 216.

The location of the user may include a geographic location (e.g., a geographic coordinate, a mail address, or a physical address), which can be obtained via GPS or Wi-Fi tracking or positioning by a location tracker of the client 202 for example. The location may also be obtained by calendar application 216, client 202 IP address, web browser, calendar application, or any other software or hardware that tracks the client location. The location of the user or client 202 can include (but is not limited to) an address, or an indication/identification of a building, a city block, a town, a street, a zip code, a district, a state, a province, a country, a continent, an intranet, a locate area network, a wide area network, a metropolitan area network, a coverage region (e.g., of an internet service provider), a domain, an area code, a time zone, or any other geographical or network region.

The location of the user may include a network address of the client 202. A physical location of the user can be determined or estimated according to the IP address of the client, for instance. The location of the user can be determined via geolocation determination by a location tracker on the client 202. For example, the location tracker and/or meeting intermediary 220 at the client 202 can communicate with a geolocation server to determine a geographical location of the client 202 or user using a network address of the client. The geolocation server can include a repository or database of information mapping physical locations to network addresses for instance.

In some embodiments, the location of the user may be known by one or more applications running on the client 202. For example, the approximate location may be known by the web browser, clock, email, weather, or other application. In some embodiments, the meeting intermediary may interface by one or more applications to determine the user's location.

In one or more embodiments, the meeting intermediary 220 may invoke a location tracker to determine the location of the user. Once invoked, the location tracker may also identify or determine the location of the user. The location tracker can include hardware (e.g., GPS receiver or Wi-Fi positioning system (WPS)) and software (e.g., GPS/WPS application, web browser, calendar application and/or the meeting intermediary 220). The location tracker may include a GPS module to determine the geographic location of the client 202. The location tracker may also identify the network address from a communication interface of the client 202.

In one or more embodiments, the preconfigured locations may be indexed in a location database by location identifiers. Each location identifier can identify or correspond to a location, which can include an office, address, a building, a city block, a town, a street, a zip code, a district, a state, a province, a country, a continent, an intranet, a locate area network, a wide area network, a metropolitan area network, a coverage region (e.g., of an internet service provider), a domain, an area code, a time zone, or any other geographical or network region.

The location of attendee(s) may be determined for the time of the event either before the event and/or at the time of the event. In some embodiments, the meeting intermediary may determine from the electronic calendar of an attendee based on other events or information in the electronic calendar that the attendee is in a location different from the location of the attendee's profile and/or location of another attendee of the meeting. The meeting intermediary may check the electronic calendar of attendees at the time of creating the event, at a predetermined time before the event or at the time of the scheduled event. In some embodiments, the meeting intermediary may determine from a device or application on a device of an attendee that an attendee is in a location different from the location of the attendee's profile and/or location of another attendee of the meeting. The meeting intermediary may check the application on the device of attendees at the time of creating the event, at a predetermined time before the event or at the time of the scheduled event. In some embodiments, the meeting intermediary may determine via a location tracker that an attendee is in a location different from the location of the attendee's profile and/or location of another attendee of the meeting. The meeting intermediary may use the location tracker at the time of creating the event, at a predetermined time before the event or at the time of the scheduled event.

In view of the above, at any time the meeting intermediary determines any of the attendees are at different location by any means, the meeting intermediary may execute the process of establishing and including an online meeting event for the meeting. For example, the attendees may be at the same location at the time of the event creation. However, then one or more attendees are traveling or out office at the time of the event and the meeting intermediary determines the same and executes the methods and techniques herein to include an online meeting.

FIG. 2B depicts the flow of events of an embodiment for creating an online meeting automatically and responsive to a meeting being initiated or created by the meeting initiator 202(1). When or as a meeting initiator 202(1) adds attendees 202(2 . . . n), or responsive to the adding of attendees, to the calendar item using a calendar application 216, the meeting intermediary can access the meeting initiator 202(1) and attendee 202(2 . . . n) profiles. The meeting intermediary 220 can obtain locations of the attendees 202(2 . . . n) via the attendee profile 218. The meeting intermediary 220 can check if the number of locations is greater than one—e.g., if one or more of the attendees 202(2 . . . n) are not in the same location.

If the number of locations is greater than one, the meeting intermediary 220 can request a meeting ID from the online meeting tool 285. The meeting intermediary can provide the online meeting tool 285 the location of the meeting attendee 202(2 . . . n) and desired time of the meeting. The online meeting can respond with a meeting ID for an online meeting. The meeting intermediary 220 will communicate the online meeting ID to the calendar application to be included with or in the meeting event or item.

If the number of locations is greater than one, the meeting intermediary 220 can send the identity of the locations to the online meeting tool 285 and request a toll-free dial in number for the time of the meeting. The online meeting tool 285 can communicate the toll-free dial in number to the meeting intermediary 220. The meeting intermediary can communicate the toll-free dial in number to the calendar application to be included in or with the meeting event or item.

FIG. 2C depicts an example of a user interface for an embodiment of an attendee profile 218 and a calendar event 217. An online meeting and local telephone numbers can be listed within the calendar event 217. This online meeting and local phone numbers can be generated by the meeting intermediary 200. In this embodiment, the meeting intermediary 200 can use the business location 240 listed in the attendee profile 218 to determine the local area code 241 of the attendee 202(2 . . . n) and time zone 242 of the attendee 202(2 . . . n). The meeting intermediary 200 interfaces with the online meeting tool 285 to communicate the attendee 202(2 . . . n) location information to the online meeting tool to generate the online meeting code 245 and local phone numbers 246. The meeting intermediary 200 can interface with the calendar application 216 to list or provide this information in the calendar event 217.

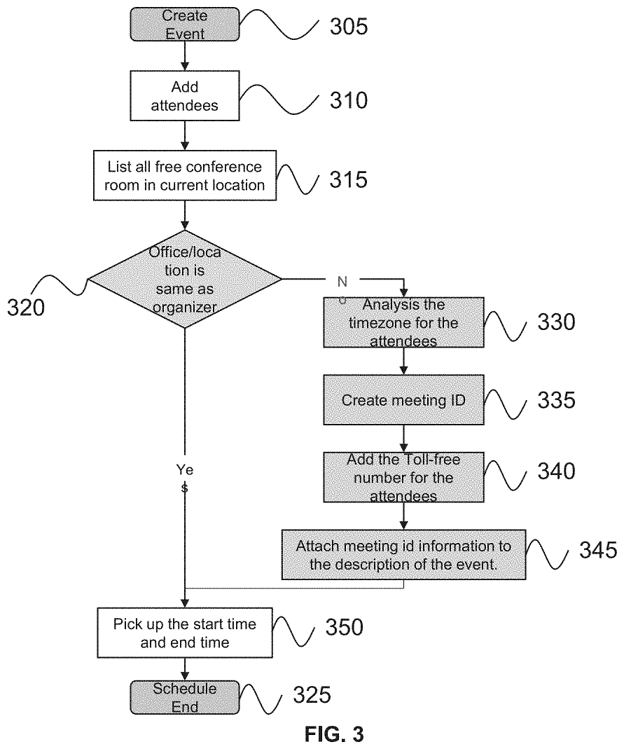

FIG. 3 depicts an embodiment of a method 300 for automatically scheduling by a meeting intermediary an online meeting. In brief overview, at step 305, the meeting intermediary 200 may detect that a calendar event 217 is being or has been created. At step, 310, the meeting intermediary 200 may detect that attendees 202(2 . . . n) have been added to the calendar event 217. At step 315, the meeting intermediary 200 may list the free or available conference rooms in the current location of an attendee 202(2 . . . n). At step 320, the meeting intermediary 200 may determine if the office/location is the same as the meeting initiator 202(1). If the meeting intermediary 200 determines the office/location is the same as the meeting initiator 202(1), the meeting intermediary may pick the start time and end time at step 325.

If the meeting intermediary determines that the office/location of the added attendee 202(2 . . . n) is not the same as the meeting initiator 202(1) at step 320, the meeting intermediary may generate an online meeting ID and toll-free telephone number in the proper time zone and area code of the added attendee. At step 330, the meeting intermediary may analyze the time zone for the attendees. At step 335, the meeting intermediary may interact with the online meeting tool to create the meeting identifier (ID). At step 340, the meeting intermediary may interact with the online meeting tool to add a phone number, such as a toll-free phone number, for one or more of the attendees based on the locations of the attendees. At step 345, the meeting intermediary may attach or include the meeting ID and phone number information to the calendar event or item 217. Although the method 300 may at time be described in context of a meeting, any type and form of calendar item may be used (e.g., appointment, event, etc.).

In further detail at step 305, a calendar item initiator or organizer may be creating or have created a calendar item such as a meeting or event via a calendar application. A meeting initiator or organizer may add a meeting or event via the user interface of the calendar application. A meeting initiator or organizer may add a meeting or event via the user interface of another application, such as social media platform or work flow tool, to be sent or added to the calendar application of the meeting initiator or organizer. The meeting initiator or organizer may accept an event from another meeting initiator or another calendar application and use that event to establish or create a calendar item, from which they may add further attendees.

At step 310, the meeting initiator may add or invite one or more attendees to the event 217. The meeting initiator may add a single attendee. The meeting initiator may add multiple attendees. The meeting initiator may add a group of attendees. The meeting initiator may add one or more attendees from the same entity or organization as the meeting initiator. The meeting initiator may add one or more attendees from an entity or organization different from the meeting initiator. The meeting initiator may add multiple attendees from an entity or organization different from the meeting initiator and different from each other. The meeting initiator may add one or more attendees from the same entity or organization different from the meeting initiator and one or more attendees from one or more entities or organizations different from the meeting initiator or another attendee. The meeting initiator may add or invite one or more attendees using any type of attendee identifier, such as an email address, contact name or social media identifier. The meeting initiator may set a date and/or time or schedule for the meeting or event.

At step 315, the calendar application or meeting intermediary may identify and provide one or more conference rooms for a location associated with one or more attendees. In one or more embodiments, the calendar application or meeting intermediary may determine one or more conference rooms within proximity to the location of one or more of the attendees or the meeting initiator. In one or more embodiments, the calendar application or meeting intermediary may determine one or more conference rooms that are free or available at a location, such as at the location of the meeting initiator or an attendee. In one or more embodiments, the calendar application or meeting intermediary may determine one or more conference rooms that are free or available at a location and a date, time or schedule of the calendar event or meeting.

At step 320, the meeting intermediary may determine whether the location of one or more of the attendees is the same or different as another attendee. The meeting intermediary may make this determination at the time of creating the event or meeting, at a predetermined time before the event or meeting and/or at the time of the event or meeting. The meeting intermediary may get the location from the meeting initiator or attendee. The location may be specified by the user, e.g., via user input using an interface of the calendar application or meeting intermediary, for instance. The meeting intermediary may obtain or identify the location of the attendee from the profile of the attendee. The meeting intermediary may obtain the location of the attendee via GPS or Wi-Fi tracking or positioning by a location tracker of the client for example. The meeting intermediary may obtain the location of the attendee based on an IP address of the device of the attendee. The meeting intermediary may obtain the location of the attendee by the calendar application 216, client 202 IP address, web browser, web application, Bluetooth®, or any other software or hardware that tracks the attendee location.

If the meeting intermediary determines that the office or location of the attendees are the same and thus an online meeting may not be required or otherwise determines an online meeting should not be included, the meeting intermediary does not generate the online meeting starting at step 330 but otherwise moves on to step 350. If the meeting intermediary determines that the office or location of any of the attendees is different and thus or otherwise an online meeting should be created and included, the meeting intermediary starts generating the online meeting starting at step 330.

At step 330, the meeting intermediary may identify the time zone for each of the attendees of the event or meeting, such as via location tracker, calendar application, device information or attendee profile. The meeting intermediary may identify the time zone for each of the attendees of the event or meeting at the time of creating the event or meeting, at a predetermined time before the event or meeting and/or at the time of the event or meeting. The meeting intermediary or calendar application may determine the time zone of each of the attendees from the attendee profile. The meeting intermediary or calendar application may determine the location of the attendees and use the location to determine the time zone of the attendee. The meeting intermediary or calendar application can calculate the time zone by converting the start and end time chosen by the meeting initiator to the local time in the attendee location. The meeting intermediary or calendar application can calculate the time zone by taking the start and end time chosen by the meeting initiator and converting the start and end time based on the number of hours that are different between the time zone of the meeting initiator and the meeting attendee.

At step 335, the meeting intermediary automatically interacts with the online meeting tool to create an online meeting to correspond with or use for the event or meeting. The meeting intermediary may interact with the online meeting tool at the time of creating the event or meeting, at a predetermined time before the event or meeting and/or at the time of the event or meeting. The meeting intermediary may automatically interact with the online meeting tool independent of any user, such as the meeting initiator. The meeting intermediary may make a request to the online meeting tool to create an online meeting and/or provide an online meeting identifier. The online meeting tool 285 can receive from the meeting intermediary the locations of the attendees. The online meeting tools 285 can return or respond with a meeting ID to the meeting intermediary 220.

At step 340, the meeting intermediary 220 interacts with the online meeting tool 285 to obtain telephone information for the online meeting, such as toll-free numbers. The meeting intermediary may obtain telephone information from or via the online meeting tool at the time of creating the event or meeting, at a predetermined time before the event or meeting and/or at the time of the event or meeting. The online meeting tool can receive from the meeting intermediary the locations of the attendees. The meeting intermediary may request toll-free telephone numbers from the online meeting tool. The online meeting tool may provide or create a list of one or more toll-free telephone numbers corresponding to the locations of the attendees. The online meeting tool may transmit the telephone numbers associated with the locations to the meeting intermediary.

At step 345, the meeting intermediary or calendar application includes, incorporates or adds the online meeting information of the online meeting tool, such as telephone numbers to the event in the calendar application for the attendees. The meeting intermediary can communicate or provide the information to the calendar application, which can add the meeting information to the event. The meeting intermediary may directly add the information to the event, such as by modifying the event in the calendar application. The meeting intermediary may incorporate or add such information at the time of creating the event or meeting, at a predetermined time before the event or meeting and/or at the time of the event or meeting.

At step 350, the calendar application or meeting intermediary may identify and provide a start time and end time for the meeting, such as based on the time zones corresponding to the locations or phone numbers. The calendar application or meeting intermediary may suggest meeting start times to the meeting initiator based on the time zone of one or more attendees, such as selected or chosen set of attendee(s). The calendar application or meeting intermediary may suggest a time or schedule the meeting such that the meeting falls between a specified time frame, for example between 9 am and 5 pm, for all meeting attendees when adjusted to a time zone, such as the local time zone of the event organizer. The calendar application or meeting intermediary may suggest a time or schedule the meeting such that the time or schedule falls during a time when no other items are scheduled on one or more attendees' calendar for the same time slot. The calendar application or meeting intermediary may suggest a time or schedule the meeting such that the time or schedule falls during a time when no other items are scheduled on an attendee) calendar for the same time slot for both the meeting initiator and all of the attendees. The calendar application or meeting intermediary may suggest a time or schedule the meeting using the constraints of first choosing a set of times possible for a specified list of necessary attendees and next selecting from that set of times the time available for the maximum number of attendees The calendar application or meeting intermediary may identify the end time based on the start time chosen by the meeting initiator and the length of the meeting desired. The meeting intermediary may identify, create, modify or adjust the start and end times of the meeting at the time of creating the event or meeting, at a predetermined time before the event or meeting and/or at the time of the event or meeting.

The calendar application may publish, share or distribute (or re-publish, re-share or re-distribute) the event or meeting with the online meeting information included or attached to the attendees, the start and end time based on time zones selected, and any conference room(s) determined to be available. In some embodiments, the meeting intermediary may cause, such as via an API call to the calendar application, the calendar application may publish, share or distribute (or re-publish, re-share or re-distribute) the event or meeting.

It should be understood that the systems described above may provide multiple ones of any or each of those components and these components may be provided on either a standalone machine or on multiple machines in a distributed system. Objects mentioned in singular may be plural. Objects mentioned in plural may be singular. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method for automatically creating an event for an online meeting tool responsive to determining attendees of a calendar item are at different locations, the method comprising:
(a) identifying, by a meeting intermediary, a plurality of attendee identifiers within a calendar item in an electronic calendar;
(b) determining, by the meeting intermediary based at least on profiles of attendees corresponding to the plurality of attendee identifiers, that a first location of a first attendee identified by a first attendee identifier of the plurality of attendee identifiers is different from a second location of a second attendee identified by a second attendee identifier of the plurality of attendee identifiers;
(c) requesting, by the meeting intermediary responsive to the determination, an online meeting identifier from an online meeting tool;
(d) receiving, by the meeting intermediary responsive to the request, a unique identifier from the online meeting tool for an event to be facilitated via the online meeting tool; and
(e) incorporating, by the meeting intermediary, the unique identifier for the event of the online meeting tool into the calendar item to be published to the plurality of attendees.

2. The method of claim 1, wherein (a) further comprising identifying the plurality of attendee identifiers responsive to the creation of the calendar item in the electronic calendar.

3. The method of claim 1, wherein (a) further comprising identifying the plurality of attendee identifiers during the creation of the calendar item in the electronic calendar.

4. The method of claim 1, wherein (b) further comprises identifying and displaying in association with the calendar item a list of meeting locations available at a location of an attendee organizing the calendar item.

5. The method of claim 1, wherein (b) further comprises computing a time zone for each of the plurality of attendees based on at least the profiles of the attendees and incorporating within the calendar item one or more telephone numbers corresponding to the time zone.

6. The method of claim 1, wherein (b) further comprises accessing, by the meeting intermediary, via the electronic calendar each of the profiles of the plurality of attendees, each of the profiles identifying a location of a corresponding attendee.

7. The method of claim 1, wherein (b) further comprises determining, by the meeting intermediary, to use an online meeting tool for the calendar item responsive to determining that the first location of the first attendee is different from the second location of the second attendee.

8. The method of claim 1, further comprising communicating, by the meeting intermediary, the one or more locations of the plurality of attendees to obtain one or more telephone numbers provided by the online meeting tool corresponding to the one or more locations.

9. The method of claim 8, further comprising incorporating the one or more telephone numbers for the event to be facilitated via the online meeting tool into the calendar item.

10. The method of claim 1, wherein the meeting intermediary comprises a component of an application providing the electronic calendar.

11. A system for automatically creating an event for an online meeting tool responsive to determining attendees of a calendar item are at different locations, the system comprising:
a meeting intermediary executing on one or more processors, coupled to memory and in communication with an electronic calendar and an online meeting tool, the meeting intermediary configured to:
identify a plurality of attendee identifiers within a calendar item of the electronic calendar;
determine, based at least on profiles of attendees corresponding to the plurality of attendee identifiers, that a first location of a first attendee identified by a first attendee identifier of the plurality of attendee identifiers is different from a second location of a second attendee identified by a second attendee identifier of the plurality of attendee identifiers;
request, responsive to the determination, an online meeting identifier from the online meeting tool;
receive, responsive to the request, a unique identifier from the online meeting tool for an event to be facilitated via the online meeting tool; and
incorporate the unique identifier for the event of the online meeting tool into the calendar item to be published to the plurality of attendees.

12. The system of claim 11, wherein the meeting intermediary is further configured to identify and display in association with the calendar item a list of meeting locations available at a location of an attendee organizing the calendar item.

13. The system of claim 11, wherein the meeting intermediary is further configured to compute a time zone for each of the plurality of attendees based on at least the profiles of the attendees and to incorporate within the calendar item one or more telephone numbers corresponding to the time zone.

14. The system of claim 11, wherein the meeting intermediary is further configured to access each of the profiles of the plurality of attendees, each of the profiles identifying a location of a corresponding attendee.

15. The system of claim 11, wherein the meeting intermediary is further configured to determine to use an online meeting tool for the calendar item responsive to determining that the first location of the first attendee is different from the second location of the second attendee.

16. A method for automatically creating an event for an online meeting tool responsive to determining attendees of a calendar item are at different locations, the method comprising:
(a) identifying, by a meeting intermediary, a plurality of attendees from a calendar item in an electronic calendar;
(b) determining, by the meeting intermediary, a location of each attendee of the plurality of attendees;
(c) determining, by the meeting intermediary, that the location of at least one attendee is different from the location of another attendee;
(d) requesting, by the meeting intermediary, an online meeting identifier from an online meeting tool;
(e) receiving, by the meeting intermediary responsive to the request, a unique identifier from the online meeting tool for an event to be facilitated via the online meeting tool; and
(f) incorporating, by the meeting intermediary, the unique identifier for the event of the online meeting tool into the calendar item to be published to the plurality of attendees.

17. The method of claim 16, wherein (a) further comprising identifying a plurality of attendee identifiers of the calendar item in the electronic calendar, each of the plurality of attendee identifiers associated with an attendee profile of one of the plurality of attendees.

18. The method of claim 17, wherein (b) further comprising determining the location of each of the plurality of attendees from the attendee profile.

19. The method of claim 16, wherein (b) further comprises determining the location of each of the plurality of attendees based on each attendee's electronic calendar.

20. The method of claim 16, wherein (f) further comprises computing a time zone for each of the plurality of attendees and incorporating within the calendar item one or more telephone numbers corresponding to the time zone.
